(19) United States
(12) Patent Application Publication
(10) Pub. No.: US 2015/0046919 A1
(43) Pub. Date: Feb. 12, 2015

(54) INFORMATION PROCESSING METHOD AND ELECTRONIC DEVICE

(71) Applicants: Lenovo (Beijing) Co., Ltd., Beijing (CN); Beijing Lenovo Software Ltd., Beijing (CN)

(72) Inventor: Yan CHEN, Beijing (CN)

(73) Assignees: LENOVO (BEIJING) CO., LTD., Beijing (CN); BEIJING LENOVO SOFTWARE LTD., Beijing (CN)

(21) Appl. No.: 14/229,877

(22) Filed: Mar. 29, 2014

(30) Foreign Application Priority Data
Aug. 8, 2013 (CN) 201310344528.6

(51) Int. Cl. G06F 9/445

(52) U.S. Cl. CPC G06F 8/60
USPC 717/178

(57) ABSTRACT

It is provided an information processing method, applied to a first electronic device including a display unit, M applications being installed in the first electronic device with M being an integer greater than or equal to 1. The method includes: detecting a first data transmission operation for transmitting a first display object of M display objects, for the M display objects displayed in a first interface of the display unit, wherein the M display objects correspond to the M applications; retrieving a first transmission file corresponding to a first application according to a predetermined rule in response to the first data transmission operation; and transmitting the first transmission file to at least one second electronic device so that the at least one second electronic device can receive and run the first transmission file to have the first application available. An electronic device is also provided.

### CROSS REFERENCES OF RELATED APPLICATION

The present application claims the priority to Chinese Patent Application No. 201310344528.6, entitled “INFORMATION PROCESSING METHOD AND ELECTRONIC APPARATUS”, filed on Aug. 8, 2013 with the State Intellectual Property Office of People's Republic of China, which is incorporated herein by reference in its entirety.

### FIELD

The present invention relates to the field of electronics and in particular to an information processing method and an electronic device.

### BACKGROUND

Installation of an application in an electronic device typically involves an installer of the application, for example, if a user wants to install an application in a handset, then the user himself or herself can download an installer package over the Internet or can have the installer package transmitted from another user, and the installer can be run after the installer package is retrieved to thereby have the corresponding application available. Moreover the application can be installed online by firstly downloading the installer package into a temporary file folder of a system and then deleting the installer package automatically at the end of installment.

The inventors of this application have identified at least the technical disadvantages discussed hereinafter in the conventional technology before technical solution according to embodiments of the disclosure.

In the conventional technology, an application shall be installed by an installer package downloaded or transmitted locally in order for sharing between users. The application has to be shared by searching a file manager for the installer package corresponding to the application and sharing the installer package, in response to an operation or operations by one or more of the users. This may result in such an issue that the user or user can not retrieve the installer package without searching in the file manager.

Moreover, if the application is installed online, there may be such a technical issue of failing to retrieve an installer packet from the file manager.

Furthermore, the user or users has or have to perform complicated operations in the course of retrieving the installer package, thus resulting in a troublesome retrieval procedure and a poor user experience.

### SUMMARY

Embodiments of the invention provide an information processing method and an electronic device so as to address such a technical problem in the prior art that if an application is installed by a installer package downloaded or transmitted locally, then a user can not retrieve the installer package without searching a file manager, so as to achieve such a technical effect that an installer package corresponding to an application can be retrieved based on an icon of the application and data can be transmitted thereto for transmission to at least one second electronic device.

In an aspect, an embodiment of this application provides an information processing method, applied to a first electronic device including a display unit, M applications being installed in the first electronic device with M being an integer greater than or equal to 1, where the method comprises:

detecting a first data transmission operation for transmitting a first display object of M display objects, for the M display objects displayed in a first interface of the display unit, where the M display objects correspond to the M applications;

retrieving a first transmission file corresponding to a first application according to a predetermined rule in response to the first data transmission operation; and

transmitting the first transmission file to at least one second electronic device so that the at least one second electronic device can receive and run the first transmission file to have the first application available.

The process of detecting a first data transmission operation for transmitting a first display object among the M display objects comprises:

detecting that a first display object of the M display objects is dragged from a first area to a data transmission area different from the first area; and

determining the first data transmission operation based on the dragging.

The process of retrieving a first transmission file corresponding to the first application according to a predetermined rule in response to the first data transmission operation comprises:

retrieving first location information of a first installer corresponding to the first application from the background of the first electronic device in response to the first data transmission operation; and

retrieving the first installer based on the first location information.

The process of retrieving first location information of a first installer corresponding to the first application from the background of the first electronic device in response to the first data transmission operation comprises:

retrieving a first profile from the background of the first electronic device in response to the first data transmission operation; and

retrieving the first location information of the first installer corresponding to the first application based on the first profile.

After the process of retrieving the first transmission file corresponding to the first application, the method further comprises:

detecting a first selection operation for selecting a data transmission mode of the first installer from at least two data transmission modes; and

determining a first data transmission mode corresponding to the first selection operation from the at least two data transmission modes as the data transmission mode of the first installer.

The transmitting the first transmission file to the at least one second electronic device comprises: transmitting the first installer to the at least one second electronic device in the first data transmission mode.

Another embodiment of the invention provides an electronic device comprising a display unit, M applications being installed in the electronic device with M being an integer greater than or equal to 1, where the electronic device comprises:

a first detection module configured to detect a first data transmission operation for transmitting a first display object of M display objects, for the M display objects corresponding to the M applications, where the M display objects are displayed in a first interface of the display unit;

a response module configured to retrieve a first transmission file corresponding to a first application according to a predetermined rule in response to the first data transmission operation; and

a transmission module configured to transmit the first transmission file to at least one second electronic device so that the at least one second electronic device can receive and run the first transmission file to have the first application available.

The first detection module is further configured to detect that a first display object of the M display objects is dragged from a first area to a data transmission area different from the first area, and determine the first data transmission operation based on the dragging.

The response module further comprises:

a first retrieval sub-module configured to retrieve first location information of a first installer corresponding to the first application from the background of the first electronic device, in response to the first data transmission operation; and

a second retrieval sub-module configured to retrieve the first installer based on the first location information.

The first retrieval sub-module further comprises:

a first retrieval unit configured to retrieve a first profile from the background of the first electronic device in response to the first data transmission operation; and

a second retrieval unit configured to retrieve the first location information of the first installer corresponding to the first application based on the first profile.

The electronic device further comprises:

a second detection module configured to detect a first selection operation for selecting a data transmission mode of the first installer from at least two data transmission modes; and

a determination module configured to determine a first data transmission mode corresponding to the first selection operation from the at least two data transmission modes as the data transmission mode of the first installer.

The transmission module is further configured to transmit the first installer to the at least one second electronic device in the first data transmission mode.

One or more of the technical solutions according to the embodiments of this application have at least the following technical disadvantages.

In the embodiments of the invention, for M display objects displayed in a first interface of the display unit, it is detected a first data transmission operation for transmitting a first display object of the M display objects, where the M display objects correspond to M applications; a first transmission file corresponding to a first application is detected according to a predetermined rule in response to the first data transmission operation; and the first transmission file to at least one second electronic device so that the at least one second electronic device can receive and run the first transmission file to have the first application available. This may address such a technical issue in the conventional technology that if an application is installed by a installer package downloaded or transmitted locally, a user can not retrieve the installer package without searching in a file manager, thereby achieving such a technical effect that an installer package corresponding to an application can be retrieved based on an icon of the application, data of which can be transmitted to at least one second electronic device.

Furthermore such a technical issue in the conventional technology is addressed that the installer can not be retrieved from a file manager because the application is installed online, and such a technical effect can be achieved that the installer corresponding to the application is retrieved at a system layer based on an icon of the application.

Furthermore the corresponding installer can be retrieved simply by accepting a data transmission operation from a user on the icon to thereby lead to a simplified retrieval procedure and a convenient operation for a good experience of the user.

### BRIEF DESCRIPTION OF THE DRAWINGS

FIG. 1 is a flow chart of an information processing method according to an embodiment of the invention;

FIG. 2 is a schematic diagram of the step 101 in the method according to an embodiment of the invention; and

FIG. 3 is a structural diagram of an electronic device according to an embodiment of the invention.

### DETAILED DESCRIPTION

Embodiments of the invention provide an information processing method and an electronic device so as to address such a technical issue in the conventional technology that a user can not retrieve an installer package without searching in a file manager if an application is installed by the installer package downloaded or transmitted locally, so as to achieve such a technical effect that an installer package corresponding to an application can be retrieved based on an icon of the application and data can be transmitted to at least one second electronic device.

In order to address the foregoing issue, a general idea of the technical solutions according to the embodiments of the invention is described as follows.

The technical solution includes the following steps: detecting whether there exists a first data transmission operation for data transmission to a first display object of M display objects, for the M display objects corresponding to the M applications, where the M display objects are displayed in a first interface of the display unit; retrieving a first transmission file corresponding to a first application according to a predetermined rule in response to the first data transmission operation, on detection of the first data transmission operation; and transmitting the first transmission file to at least one second electronic device so that the at least one second electronic device can receive and run the first transmission file to have the first application available. This may address such a technical issue in the conventional technology that if an application is installed by an installer package downloaded or transmitted locally, then a user can not retrieve the installer package without searching in a file manager, so as to achieve such a technical effect that an installer package corresponding to an application can be retrieved based on an icon of the application and data can be transmitted to at least one second electronic device.

For better understanding, the foregoing technical solution will be detailed below with reference to the drawings and embodiments.

An embodiment of this application provides an information processing method applied to a first electronic device including a display unit. The first electronic device may be a handset, a tablet computer, a computer or another electronic device with a display screen. The display screen may be a display screen with a touch control function or may be a screen with only a display function. M applications are installed in the first electronic device, M is an integer greater than or equal to 1, and the applications are not bundled with a system but installed by a user himself or herself.

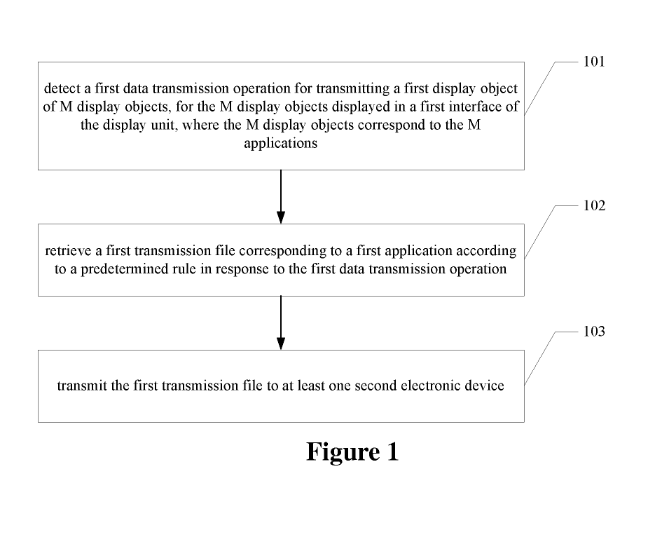

FIG. 1 illustrates the information processing method steps.

In step 101, for M display objects displayed in a first interface of the display unit, a first data transmission operation for transmitting a first display object of the M display objects is detected, where the M display objects correspond to the M applications.

In this embodiment, the first data transmission operation is a sharing operation for transmitting the first display object or another operation.

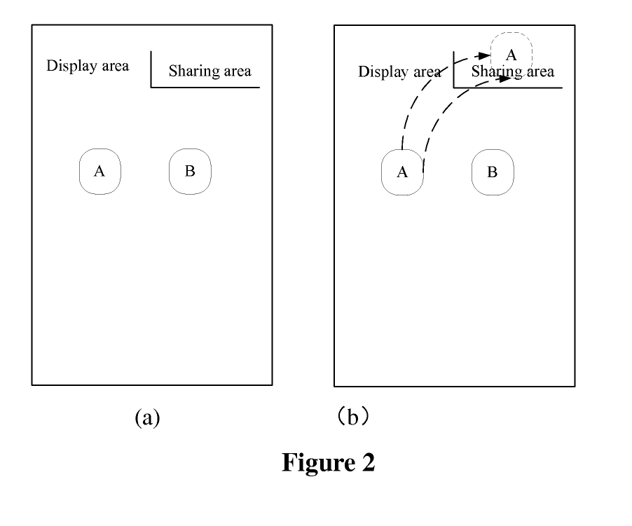

In a particular implementation, in the case that the display screen of the electronic device is operative, the display screen provides a display interface in which at least one icon corresponding to the applications is displayed. As illustrated in FIG. 2(a), an icon A corresponds to an application A, an icon B corresponds to an application B, and the application A or B may be run by clicking on the corresponding icon. In this case, the electronic device detects whether there exists a sharing operation by a user on the at least one icon. In practice, the user can perform the sharing operation on only one icon at a time, or may firstly select a plurality of icons and then perform the sharing operation collectively on the plurality of icons, for example, the user shares only the application A, or, both the application A and the application B simultaneously.

The step 101 includes: detecting that a first display object of the M display objects is dragged from a first area to a data transmission area different from the first area, determining the first data transmission operation based on the dragging.

In a particular implementation, the display interface displays a display area where the icons are currently located and a sharing area where a sharing operation needs to be performed. The electronic device determines a sharing operation on an icon by detecting a dragging of the icon from the display area to the sharing area in response to the operation by the user. The operation of sharing by dragging may be performed by a touch control operation of the user on a touch control display screen or may be performed by operating a mouse or another input device in the electronic device using a display screen without a touch control function. For example, as illustrated in FIG. 2(b), the application A is dragged from the display area to the sharing area. Furthermore, if both the application A and the application B are shared simultaneously, both the application A and the application B are dragged into the sharing area after being selected. The dragging of the icon by the user from the display area to the sharing area indicates that there is a sharing operation to share the application corresponding to the icon.

Furthermore, the sharing operation may be embodied as others, for example, a sharing function as an elementary operation functions is added for display objects, and in this case, the display object is selected and the “Sharing Function” is selected, for example, the icon is right-clicked on by a mouse, then the “Sharing Function” is left-clicked on and selected to perform the sharing operation, or the display object is pressed for a long time to perform the sharing operation, etc. In another example, a sharing operation may be performed by the user either clocking on the “Sharing Function” or pressing the display object for a long time. The embodiments of the sharing operation are not limited.

Step 102 is performed in the embodiment of this application after the step 101. The step 102 includes: retrieving a first transmission file corresponding to a first application according to a predetermined rule in response to the first data transmission operation.

In an embodiment, the step 102 includes:

retrieving first location information of a first installer corresponding to the first application from the background of the first electronic device in response to the first data transmission operation; and

retrieving the first installer based on the first location information.

In a particular implementation, in response to the sharing operation by the user on the icon, the electronic device retrieves a profile from an installment directory of applications at the background of the electronic device. The profile includes installers of respective applications at a system layer. Location information of an installer of the application, on which the sharing operation is performed, in the electronic device can be retrieved. Furthermore, the installer corresponding to the application may be retrieved for the user based on the location information.

The step 102 will be detailed in two embodiments of this application.

In a first embodiment, taking the Android operating system as an example, if an installation directory of a LeStore shop is “sdcard/lestore”, a profile is retrieved as “sdcard/lestore/lestore.config”, and next the location information of the installer corresponding to the application A is retrieved from the profile of lestore.config as “sdcard/lestore/download”, and furthermore, the installer file of the application A is retrieved as “sdcard/lestore/download/lestore.20121111.A.apk”. The installation directory, the profile, the location information and the installer file are defaulted in a hidden status and may be browsed only with a root privilege.

In a second embodiment, taking the Windows 8 system as an example, if an installation directory of a Windows application shop is “C:\windows\windows store\app”, a profile is retrieved as “C:\windows\windows store\app\config.ini”, and next the location of the installer corresponding to the application A is retrieved from the profile of config.ini as “C:\windows\windows store\app\download”, and furthermore, the installer file of the application A is retrieved as “C:\windows\windows store\app\download\A.xap”.

After the step 102, the embodiment of this application further includes the following steps:

detecting a first selection operation for selecting a data transmission mode of the first installer from at least two data transmission modes; and

determining a first data transmission mode corresponding to the first selection operation is determined from the at least two data transmission modes as the data transmission mode of the first installer.

In a particular implementation, for the first installer, there are various sharing modes including a sharing mode provided by a third-party application. For example, if a micro-blog application is installed in the electronic device, the installer may be shared via a micro-blog, in addition to sharing modes bundled with the system, e.g., sharing via a short message, an email sharing mode, etc.

After the installer is retrieved, the embodiment of this application includes step 103 of transmitting the first transmission file to at least one second electronic device.

In a particular implementation, the installer of the application may be shared in any of the various sharing modes mentioned above after the installer is retrieved in response to the selection by the user. The installer may be in the format of “.apk”, “.ipa”, “.xap” or “.exe” or the like. The file in such format is shared with other users, and the other users obtaining the file may run the installer to have the corresponding application available in their electronic devices.

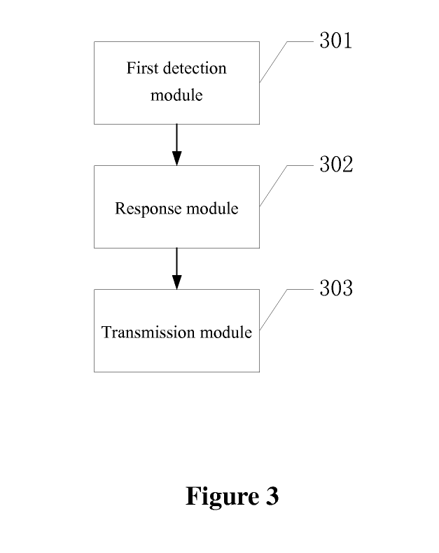

Based on this inventive concept, another embodiment of this application provides an electronic device including a display unit, where M applications are installed in the electronic device, and M is an integer greater than or equal to 1. As illustrated in FIG. 3, the electronic device includes:

a first detection module 301 configured to detect a first data transmission operation for transmitting a first display object of M display objects, for the M display objects corresponding to the M applications, where the M display objects are displayed in a first interface of the display unit;

a response module 302 configured to retrieve a first transmission file corresponding to a first application according to a predetermined rule in response to the first data transmission operation; and

a transmission module 303 configured to transmit the first transmission file to at least one second electronic device so that the at least one second electronic device can receive and run the first transmission file to have the first application available.

In an embodiment of this application, the first detection module 301 is further configured to detect that a first display object of the M display objects is dragged from a first area to a data transmission area different from the first area, and determine the first data transmission operation based on the dragging.

In an embodiment of this application, the response module 302 further includes:

a first retrieval sub-module, configured to retrieve first location information of a first installer corresponding to the first application from the background of the first electronic device in response to the first data transmission operation; and

a second retrieval sub-module, configured to retrieve the first installer based on the first location information.

In an embodiment of this application, the first retrieval sub-module further includes:

a first retrieval unit, configured to retrieve a first profile from the background of the first electronic device in response to the first data transmission operation; and

a second retrieval unit, configured to retrieve the first location information of the first installer corresponding to the first application based on the first profile.

In an embodiment of this application, the electronic device further includes:

a second detection module, configured to detect a first selection operation for selecting a data transmission mode of the first installer from at least two data transmission modes; and

a determination module, configured to determine a first data transmission mode corresponding to the first selection operation from the at least two data transmission modes as the data transmission mode of the first installer.

In an embodiment of this application, the transmission module is further configured to transmit the first installer to the at least one second electronic device in the first data transmission mode.

Since the electronic device according to this embodiment is an electronic device for use in performing the information processing method according to the embodiment of this application, those skilled in the art can appreciate from the information processing method according to the embodiment of this application particular embodiments of electronic device according to the embodiment of this application and various variants thereof, so a detailed description of the electronic device will be omitted here. Any electronic device for use by those skilled in the art in performing the information processing method according to the embodiment of this application will fall into the scope of this application.

One or more of the technical solutions according to the embodiments of this application have at least the following technical disadvantages.

In the embodiments of the invention, for M display objects displayed in a first interface of the display unit, it is detected a first data transmission operation for transmitting a first display object of the M display objects, where the M display objects correspond to M applications; a first transmission file corresponding to a first application is detected according to a predetermined rule in response to the first data transmission operation; and the first transmission file to at least one second electronic device so that the at least one second electronic device can receive and run the first transmission file to have the first application available. This may address such a technical issue in the conventional technology that if an application is installed by a installer package downloaded or transmitted locally, a user can not retrieve the installer package without searching in a file manager, thereby achieving such a technical effect that an installer package corresponding to an application can be retrieved based on an icon of the application, data of which can be transmitted to at least one second electronic device.

Furthermore such a technical issue in the conventional technology is addressed that the installer can not be retrieved from a file manager because the application is installed online, and such a technical effect can be achieved that the installer corresponding to the application is retrieved at a system layer based on an icon of the application.

Furthermore the corresponding installer can be retrieved simply by accepting a data transmission operation from a user on the icon to thereby lead to a simplified retrieval procedure and a convenient operation for a good experience of the user.

Evidently those skilled in the art can make various modifications and variations to the invention without departing from the spirit and scope of the invention. Thus the invention is also intended to encompass these modifications and variations thereto so long as the modifications and variations come into the scope of the claims appended to the invention and their equivalents.

1. An information processing method, applied to a first electronic device including a display unit, M applications being installed in the first electronic device with M being an integer greater than or equal to 1, wherein the method comprises:
detecting a first data transmission operation for transmitting a first display object of M display objects, for the M display objects displayed in a first interface of the display unit, wherein the M display objects correspond to the M applications;
retrieving a first transmission file corresponding to a first application according to a predetermined rule in response to the first data transmission operation; and
transmitting the first transmission file to at least one second electronic device so that the at least one second electronic device can receive and run the first transmission file to have the first application available.

2. The method according to claim 1, wherein the process of detecting a first data transmission operation for transmitting a first display object among the M display objects comprises:
detecting that a first display object of the M display objects is dragged from a first area to a data transmission area different from the first area; and
determining the first data transmission operation based on the dragging.

3. The method according to claim 1, wherein the process of retrieving a first transmission file corresponding to the first application according to a predetermined rule in response to the first data transmission operation comprises:
retrieving first location information of a first installer corresponding to the first application from the background of the first electronic device in response to the first data transmission operation; and
retrieving the first installer based on the first location information.

4. The method according to claim 3, wherein the process of retrieving first location information of a first installer corresponding to the first application from the background of the first electronic device in response to the first data transmission operation comprises:
retrieving a first profile from the background of the first electronic device in response to the first data transmission operation; and
retrieving the first location information of the first installer corresponding to the first application based on the first profile.

5. The method according to claim 4, wherein after the process of retrieving the first transmission file corresponding to the first application, the method further comprises:
detecting a first selection operation for selecting a data transmission mode of the first installer from at least two data transmission modes; and
determining a first data transmission mode corresponding to the first selection operation from the at least two data transmission modes as the data transmission mode of the first installer.

6. The method according to claim 5, wherein the transmitting the first transmission file to the at least one second electronic device comprises:
transmitting the first installer to the at least one second electronic device in the first data transmission mode.

7. An electronic device comprising a display unit, M applications being installed in the electronic device with M being an integer greater than or equal to 1, wherein the electronic device comprises:
a first detection module configured to detect a first data transmission operation for transmitting a first display object of M display objects, for the M display objects corresponding to the M applications, wherein the M display objects are displayed in a first interface of the display unit;
a response module configured to retrieve a first transmission file corresponding to a first application according to a predetermined rule in response to the first data transmission operation; and
a transmission module configured to transmit the first transmission file to at least one second electronic device so that the at least one second electronic device can receive and run the first transmission file to have the first application available.

8. The electronic device according to claim 7, wherein the first detection module is further configured to detect that a first display object of the M display objects is dragged from a first area to a data transmission area different from the first area, and determine the first data transmission operation based on the dragging.

9. The electronic device according to claim 7, wherein the response module further comprises:
a first retrieval sub-module configured to retrieve first location information of a first installer corresponding to the first application from the background of the first electronic device, in response to the first data transmission operation; and
a second retrieval sub-module configured to retrieve the first installer based on the first location information.

10. The electronic device according to claim 9, wherein the first retrieval sub-module further comprises:
a first retrieval unit configured to retrieve a first profile from the background of the first electronic device in response to the first data transmission operation; and
a second retrieval unit configured to retrieve the first location information of the first installer corresponding to the first application based on the first profile.

11. The electronic device according to claim 10, wherein the electronic device further comprises:
a second detection module configured to detect a first selection operation for selecting a data transmission mode of the first installer from at least two data transmission modes; and
a determination module configured to determine a first data transmission mode corresponding to the first selection operation from the at least two data transmission modes as the data transmission mode of the first installer.

12. The electronic device according to claim 11, wherein the transmission module is further configured to:
transmit the first installer to the at least one second electronic device in the first data transmission mode.
